(19) United States
(12) Patent Application Publication
(10) Pub. No.: US 2007/0290543 A1
(43) Pub. Date: Dec. 20, 2007

(54) Motorcycle passenger connector

(76) Inventor: Jelani N. James, Pearland, TX (US)

Correspondence Address: Raymond M. Galasso;Galasso & Associates LP, P.O. Box 26503, Austin, TX, 78755-0503, US

(21) Appl. No.: 11/789,217

(22) Filed: Apr. 23, 2007

Related U.S. Application Data
(60) Provisional application No. 60/814,610, filed on Jun. 16, 2006.

(51) Int. Cl. A62B 35/00

(52) U.S. Cl. 297/468

(57) ABSTRACT

Motorcycle Passenger Connector is a double harness design to link a motorcycle passenger and a motorcycle operator. The preferred embodiment of the invention utilizes a connector with clasps and two harnesses with straps and a connector chain. To use the preferred embodiment of Motorcycle Passenger Connector, the motorcycle operator and the passenger would use the straps and buckles to secure the harnesses around their waists. The motorcycle operator would arrange his harness to have the straps and buckle on his front while the harness would be arranged on his back with the chain emanating from the rear. The motorcycle passenger would arrange his harness to have the straps and buckle on the rear of his body while the harness would be on his front with the chain emanating from the front. Both the motorcycle operator and the passenger would then climb on the motorcycle, and the passenger would fasten both chains to the connector using the clasps.

### CROSS REFERENCE TO RELATED APPLICATIONS

This United States Non-Provisional Patent Application claims priority to U.S. Provisional Patent Application No. 60/814,610 entitled “Motorcycle Passenger Connector” filed Jun. 16, 2006.

### FIELD OF THE DISCLOSURE

The disclosures made herein relate generally to the motorcycle accessories industry. The invention discussed herein is in the general classification of motorcycle passenger harnesses.

### BACKGROUND

Travel on motorized vehicles can be dangerous. Careless motor vehicle operators, weather and a variety of other factors out of the control of a vehicle operator can cause accidents. Travel on motorcycles can be particularly hazardous because no exterior body surrounds the vehicle operator.

A motorcycle operator often chooses to carry a passenger on the rear of his motorcycle. The additional passenger can cause instability on the motorcycle. The passenger often feels unsafe and lacks the freedom to move for fear of creating an unstable condition on the motorcycle, particularly when the motorcycle is turning a corner. Traditionally, a passenger merely wraps his arms around the motorcycle operator's body and attempts to lean whenever the operator leans in a certain direction to maintain balance.

Hence, there is a need in the art for a convenient to use, inexpensive, durable, safe, and effective device for harnessing a motorcycle passenger to a motorcycle operator.

### SUMMARY OF THE DISCLOSURE

Motorcycle Passenger Connector is a double harness design to link a motorcycle passenger and a motorcycle operator.

The preferred embodiment of the invention utilizes a connector with clasps and two harnesses with straps and a connector chain.

Certain embodiments of the invention may incorporate different style and shape harnesses, straps, connectors or clasps.

The principal object of this invention is to provide a device that allows the passenger on a motorcycle to be attached to the motorcycle operator.

Another object of this invention is to provide an easily used device to attach the passenger on a motorcycle to the motorcycle operator.

Another object of this invention is to provide an affordable device for attaching a passenger on a motorcycle to the motorcycle operator.

Another object of this invention is to provide a light-weight device for attaching a passenger on a motorcycle to the motorcycle operator.

Another object of this invention is to provide a safe device for attaching a passenger on a motorcycle to the motorcycle operator.

Yet another object of this invention is to provide a durable device for attaching a passenger on a motorcycle to the motorcycle operator.

### BRIEF DESCRIPTION OF THE DRAWINGS

FIG. 1 depicts a perspective view of the preferred embodiment of the connector of the present invention.

FIG. 2 depicts a perspective view of the preferred embodiment of the harness and chain of the present invention.

### DETAILED DESCRIPTION OF THE DRAWINGS

The preferred embodiment of Motorcycle Passenger Connector is comprised of at least some of the following: a connector with clasps and two harnesses with straps and a connector chain.

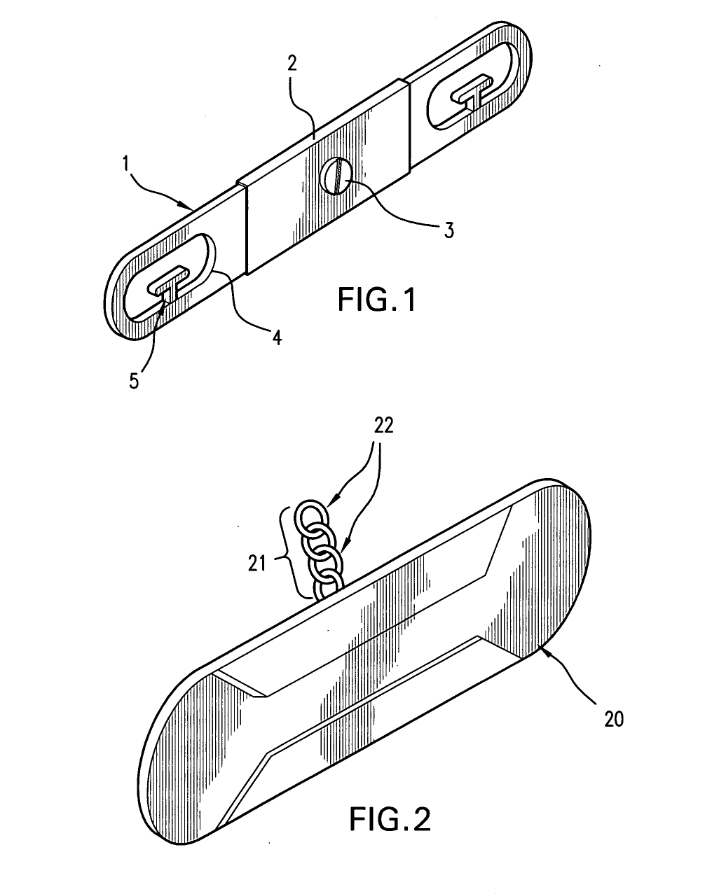

FIG. 1 depicts a perspective view of the preferred embodiment of the connector of the present invention. The preferred embodiment of the connector 1 is approximately rectangular in shape with rounded ends. The connector 1 is made of metal and is approximately seven inches in length, two inches in width and one-quarter of an inch in thickness though a variety of shapes, sizes and materials could be utilized. A metal plate 2 is attached to the center of the connector via a screw 3 to reinforce the connector 1. The metal plate 2 is approximately three inches in length and dimensioned to fit around the connector 1.

Openings 4 are present on each end of the connector 1. The openings 4 are oval in shape in this preferred embodiment and extend one inch and width and an inch and a half in length. Clasps 5 in T-shapes are attached to the connector 1 in the center and bottom of the openings 4. The clasps 5 are quarter of an inch in height and half an inch in length in this preferred embodiment.

FIG. 2 depicts a perspective view of the preferred embodiment of the harness and chain of the present invention. The harness 20 is thirty inches in length, six inches in width and half an inch in thickness. The harness 20 is made of leather in this preferred embodiment though a variety of materials, especially tough, abrasion resistant ones, could be utilized.

A chain 21 made of metal is attached to one side of the harness 20. The chain 21 has several individual links 22 and extends approximately six inches from the center of the harness 20 in this preferred embodiment.

Straps, not pictured, but well-known in the art, can be attached to the harness 20 opposite the chain 21. The straps can be made of nylon or other suitable material and will have a buckle of metal or plastic or other suitable material to hold the harness around the user's waist.

Other embodiments of the device may utilize a single clasp on the connector and may have different style harnesses well-known in the art.

To use the preferred embodiment of Motorcycle Passenger Connector, the motorcycle operator and the passenger would use the straps and buckles to secure the harnesses around their waists. The motorcycle operator would arrange his harness to have the straps and buckle on his front while the harness would be arranged on his back with the chain emanating from the rear. The motorcycle passenger would arrange his harness to have the straps and buckle on the rear of his body while the harness would be on his front with the chain emanating from the front. Both the motorcycle operator and the passenger would then climb on the motorcycle, and the passenger would fasten both chains to the connector using the clasps. After use, the harnesses can be removed, detached from the connector and stored.

The materials utilized for Motorcycle Passenger Connector may vary widely but will likely include metal and plastic components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Motorcycle Passenger Connector can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the components of the present invention can be of various shapes and sizes. It should also be obvious that the components of the invention can be made of different types of plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A motorcycle passenger and operator connecting device comprising:
(a) a connector having a clasp;
(b) a first chain emanating from a first harness; and
(c) a second chain emanating from a second harness.

2. The device of claim 1 wherein the connector is approximately rectangular.

3. The device of claim 1 wherein the connector is made of metal.

4. The device of claim 1 wherein the connector is approximately seven inches in length, two inches in width and one-quarter of an inch in thickness.

5. The device of claim 1 further comprising
a metal plate attached to the center of the connector via a screw.

6. The device of claim 5 wherein the metal plate is approximately three inches in length and dimensioned to fit around the connector.

7. The device of claim 1 further comprising
an opening containing the clasp.

8. The device of claim 7 wherein the opening is oval.

9. The device of claim 1 wherein the clasp is T-shaped

10. The device of claim 7 wherein the clasp is located in the center of the opening.

11. The device of claim 1 wherein the first harness and the second harness are thirty inches in length, six inches in width and half an inch in thickness.

12. The device of claim 1 wherein the first harness and the second harness are made of leather.

13. The device of claim 1 wherein the first chain and the second chain are made of metal and are approximately six inches in length.

14. The device of claim 1 wherein the first harness has a first set of straps made of nylon opposite the first chain and a first buckle made of metal to connect the first set of straps and the second harness has a second set of straps made of nylon opposite the second chain and a second buckle made of metal to connect the second set of straps.

15. A motorcycle passenger and operator connecting device comprising:
(a) a connector having a first opening on one end and a second opening on the opposite end;
(b) a first T-shaped clasp located in approximately the center of the first opening and a second T-shaped clasp located in approximately the center of the second opening;
(c) a metal plate attached to the center of the connector via a screw;
(d) a chain emanating from one side of a first harness and a first set of straps with a first buckle on the opposite side of the first harness; and
(e) a second chain emanating from one side of a second harness and a second set of straps with a second buckle on the opposite side of the second harness.

16. The device of claim 15 wherein the connector, the first T-shaped clasp and the second T-shaped clasp are made of metal.

17. The device of claim 15 wherein the first harness and the second harness are made of leather.
